(19) United States
(12) Patent Application Publication
(10) Pub. No.: US 2017/0114206 A1
(43) Pub. Date: Apr. 27, 2017

(54) Recycling of Pressure-Sensitive Adhesive Laminates

(71) Applicant: Geo-Tech Polymers, LLC, Westerville, OH (US)

(72) Inventors: Sreevalli Bokka, Chillicothe, OH (US); Chad C. Smith, Waverly, OH (US); John S. Essman, Wheelersburg, OH (US); David M. Bender, Glencoe, IL (US); Ronald L. Whaley, Portsmouth, OH (US)

(21) Appl. No.: 15/298,987

(22) Filed: Oct. 20, 2016

Related U.S. Application Data
(60) Provisional application No. 62/245,416, filed on Oct. 23, 2015.

(51) Int. Cl. C08J 11/24; B32B 38/10; B32B 43/00; C08J 11/16

(52) U.S. Cl. CPC C08J 11/24; C08J 11/16; B32B 38/10; B32B 43/006; C08J 2400/30; B32B 2519/00

(57) ABSTRACT

Methods, compositions, single-phase aqueous solutions, process mixtures, and kits are provided relating to recycling a pressure-sensitive adhesive laminate using a single-phase aqueous solution. For example, a method of recycling a pressure-sensitive adhesive laminate may include providing the single-phase aqueous solution. The single-phase aqueous solution may include water and a surfactant composition. The method may include providing the pressure-sensitive adhesive laminate. The pressure-sensitive adhesive laminate may include: a facestock including a label surface and an adhesion surface; a release liner including a release surface; and a pressure-sensitive adhesive coated on the adhesion surface of the facestock, the release surface of the release liner being laminated to the adhesion surface of the facestock through the pressure-sensitive adhesive. The method may include contacting the single-phase aqueous solution and the pressure-sensitive adhesive laminate to form a process mixture under conditions effective to provide a recycled portion of the pressure-sensitive adhesive laminate.

### CROSS-REFERENCE TO RELATED APPLICATIONS

This application claims priority to U.S. Provisional Patent Application No. 62/245,416, filed on Oct. 23, 2015, which is incorporated by reference herein in its entirety.

### BACKGROUND

Pressure-sensitive labels generate nearly 2 billion pounds of waste added to landfills annually. The large and increasing volumes of pressure-sensitive label waste is a significant industrial and environmental concern, particularly for pressure-sensitive laminate scrap that remains after desired label portions are cut or removed from a sheet of pressure-sensitive label laminate. However, major obstacles prevent achieving economical and effective recycling of pressure-sensitive labels, particularly pressure-sensitive laminate scrap. Current methods of recycling the paper and polymer sheets used in pressure-sensitive labels are generally incompatible with simultaneously separating or recycling the pressure-sensitive adhesive located between the layers of the pressure-sensitive label laminate. In addition, pressure-sensitive label laminates may include inks, coatings, dyes, release agents, and other components which may be incompatible with current methods for recycling paper and polymer sheets, as well as pressure-sensitive adhesives.

The present application appreciates that recycling pressure-sensitive labels and pressure-sensitive composites may be a challenging endeavor.

### SUMMARY

In one embodiment, a process mixture is provided. The process mixture may include a pressure-sensitive adhesive laminate in contact with a single-phase aqueous solution. The single-phase aqueous solution may include water and a surfactant composition. The pressure-sensitive adhesive laminate may include a facestock. The facestock may include a label surface and an adhesion surface. The pressure-sensitive adhesive laminate may include a release liner. The release liner may include a release surface. The pressure-sensitive adhesive laminate may include a pressure-sensitive adhesive coated on the adhesion surface of the facestock. The release surface of the release liner may be laminated to the adhesion surface of the facestock through the pressure-sensitive adhesive to form the pressure-sensitive adhesive laminate.

In another embodiment, a method is provided for recycling a pressure-sensitive adhesive laminate using a single-phase aqueous solution. The method may include providing the single-phase aqueous solution. The single-phase aqueous solution may include water and a surfactant composition. The method may include providing the pressure-sensitive adhesive laminate. The pressure-sensitive adhesive laminate may include a facestock. The facestock may include a label surface and an adhesion surface. The pressure-sensitive adhesive laminate may include a release liner. The release liner may include a release surface. The pressure-sensitive adhesive laminate may include a pressure-sensitive adhesive coated on the adhesion surface of the facestock. The release surface of the release liner may be laminated to the adhesion surface of the facestock through the pressure-sensitive adhesive to form the pressure-sensitive adhesive laminate. The method may include contacting the single-phase aqueous solution and the pressure-sensitive adhesive laminate to form a process mixture under conditions effective for delaminating at least a portion of the pressure-sensitive adhesive laminate to provide a recycled portion of the pressure-sensitive adhesive laminate.

In one embodiment, a kit is provided. The kit may be for recycling a pressure-sensitive adhesive laminate. The kit may include a surfactant composition. The kit may include instructions. The instructions may direct a user to combine the surfactant composition with water to form the single-phase aqueous solution. The instructions may direct the user to contact the single-phase aqueous solution and the pressure-sensitive adhesive laminate to form a process mixture under conditions effective to provide a recycled portion of the pressure-sensitive adhesive laminate.

In another embodiment, a recycled portion of a pressure-sensitive adhesive laminate is provided. The recycled portion of the pressure-sensitive adhesive laminate may include one or more of: a facestock, a release liner, a pressure-sensitive adhesive, a tackifier, a release agent, an abrasion coating, a textured coating, an ultraviolet-resistant coating, a clear coating, an ink, a dye, a paint, a pigment, a scented coating, and a decomposition product thereof. The recycled portion of the pressure-sensitive adhesive laminate may be produced by a method for recycling a pressure-sensitive adhesive laminate using a single-phase aqueous solution. The method may include providing the single-phase aqueous solution. The single-phase aqueous solution may include water and a surfactant composition. The method may include providing the pressure-sensitive adhesive laminate. The pressure-sensitive adhesive laminate may include the facestock. The facestock may include a label surface and an adhesion surface. The pressure-sensitive adhesive laminate may include the release liner. The release liner may include a release surface. The pressure-sensitive adhesive laminate may include the pressure-sensitive adhesive coated on the adhesion surface of the facestock. The release surface of the release liner may be laminated to the adhesion surface of the facestock through the pressure-sensitive adhesive to form the pressure-sensitive adhesive laminate. The method may include contacting the single-phase aqueous solution and the pressure-sensitive adhesive laminate to form a process mixture under conditions effective for delaminating at least a portion of the pressure-sensitive adhesive laminate to provide the recycled portion of the pressure-sensitive adhesive laminate.

In another embodiment, a recycled portion of a pressure-sensitive adhesive laminate is provided. The recycled portion of the pressure-sensitive adhesive laminate may include one or more of: a facestock, a release liner, a pressure-sensitive adhesive, a tackifier, a release agent, an abrasion coating, a textured coating, an ultraviolet-resistant coating, a clear coating, an ink, a dye, a paint, a pigment, a scented coating, and a decomposition product thereof. The recycled portion of the pressure-sensitive adhesive laminate may be derived from a process mixture. The process mixture may include the pressure-sensitive adhesive laminate in contact with a single-phase aqueous solution. The single-phase aqueous solution may include water and a surfactant composition. The pressure-sensitive adhesive laminate may include the facestock. The facestock may include a label surface and an adhesion surface. The pressure-sensitive adhesive laminate may include the release liner. The release liner may include a release surface. The pressure-sensitive adhesive laminate may include the pressure-sensitive adhesive coated on the adhesion surface of the facestock. The release surface of the release liner may be laminated to the adhesion surface of the facestock through the pressure-sensitive adhesive to form the pressure-sensitive adhesive laminate.

### BRIEF DESCRIPTION OF THE DRAWINGS

The accompanying figures, which are incorporated in and constitute a part of the specification, illustrate example methods and apparatuses, and are used merely to illustrate example embodiments.

FIG. 1 is an illustration of an example pressure-sensitive adhesive laminate.

FIG. 2 is a flow diagram describing an example method for recycling a pressure-sensitive adhesive laminate using a single-phase aqueous solution.

FIG. 3 is a block diagram of an example kit for recycling a pressure-sensitive adhesive laminate using a single-phase aqueous solution.

### DETAILED DESCRIPTION

The present application relates to compositions, process mixtures, methods, and kits relating to recycling a pressure-sensitive adhesive laminate.

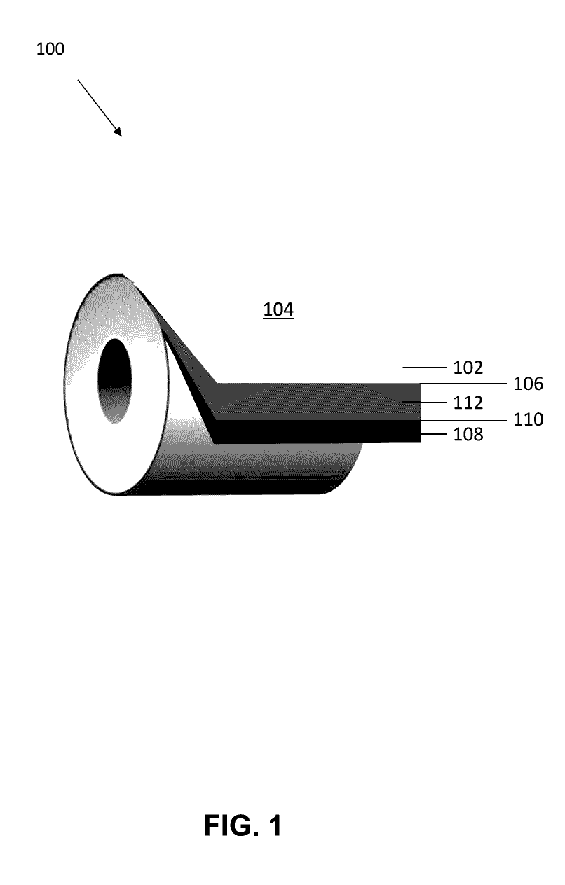

In various embodiments, a process mixture is provided. The process mixture may include a pressure-sensitive adhesive laminate in contact with a single-phase aqueous solution. The single-phase aqueous solution may include water and a surfactant composition. FIG. 1 is an illustration of an example pressure-sensitive adhesive laminate 100. Pressure-sensitive adhesive laminate 100 may include a facestock 102. Facestock 102 may include a label surface 104 and an adhesion surface 106. Pressure-sensitive adhesive laminate 100 may include a release liner 108. Release liner 108 may include a release surface 110. Pressure-sensitive adhesive laminate 100 may include a pressure-sensitive adhesive 112 coated on adhesion surface 106 of facestock 102. Release surface 110 of release liner 108 may be laminated to adhesion surface 106 of facestock 102 through pressure-sensitive adhesive 112 to form pressure-sensitive adhesive laminate 100. Pressure-sensitive adhesive laminate 100 may include any commercially available pressure-sensitive adhesive laminates, such as pressure-sensitive labels sold by Avery-Dennison, Glendale, Calif., pressure-sensitive tapes such as those sold by 3M Corporation, St. Paul Minn., and the like.

In some embodiments, the pressure-sensitive adhesive laminate may be in the form of a plurality of pieces. The plurality of pieces of the pressure-sensitive adhesive laminate may be derived by one or more of: shredding, grinding, and cutting the pressure-sensitive adhesive laminate. The pressure-sensitive adhesive laminate, prior to shredding, grinding, or cutting, may be in the form of one or more of: a sheet, a roll, a remnant, a sample, a labeling scrap, a manufacturing scrap, and the like.

In several embodiments, the facestock may include one or more of: a polymer film, a metallized polymer film, a metal foil, a paper, a resin-bonded paper, a coated paper, a synthetic paper, a flashspun fabric, a polymer film-paper laminate, a metallized paper, an elastomeric foam, a woven textile, a nonwoven textile, and the like. The facestock may include combinations thereof, e.g., a polymer film combined with a textile, a metallized paper combined with a polymer film, and the like. The facestock may include a layer of one or more of: cellulose acetate, cellulose triacetate, cellulose acetobutyrate, cellulose hydrate, polyethylene, polypropylene, polyethylene/polystyrene, oriented polypropylene, biaxially oriented polypropylene, cast polypropylene, polyethylene terephthalate, biaxially oriented polyethylene terephthalate, polystyrene, polystyrene-butadiene, polyamide, polyamide/aluminum, polyvinyl chloride, and the like. The facestock may include one or more of an oriented polymer film and a biaxially oriented polymer film. The facestock may include a synthetic paper formed of bonded polyolefin fibers, e.g., the synthetic paper formed of bonded polypropylene fibers sold under the tradename TYVEK® (DuPont, Wilmington, Del.). For example, the facestock may include a synthetic paper formed of bonded polypropylene fibers.

In various embodiments, the facestock may include a primer coating on the adhesion surface. The primer coating may be configured to facilitate adhesion of the pressure-sensitive adhesive to the adhesion surface of the facestock. The primer coating may be any such coating known to the art.

In some embodiments, the label surface of the facestock may include or may be in contact with one or more of: an abrasion coating, a textured coating, an ultraviolet-resistant coating, a clear coating, an ink, a dye, a paint, a pigment, and a scented coating.

In several embodiments, the release liner and the facestock may each include a layer of the same material, e.g., the release liner and the facestock may each include polyethylene terephthalate. In some embodiments, the release liner and the facestock may each include a layer of different material, e.g., the facestock may include a synthetic paper formed of bonded polypropylene fibers and the release liner may include polyethylene terephthalate.

In various embodiments, the release liner may include one or more of: a polymer film, a paper, a resin-bonded paper, a coated paper, a synthetic paper, a polymer film-paper laminate, combinations thereof; and the like. For example, the release liner may include a polymer film of one or more of: a polyester, a polyolefin, a cellulose derivative, a polystyrene, a polyvinyl, a polyamide, and the like. For example, the release liner may include a layer of one or more of: cellulose acetate, cellulose triacetate, cellulose acetobutyrate, cellulose hydrate, polyethylene, low density polyethylene, high density polyethylene, polypropylene, polyethylene/polystyrene, oriented polypropylene, biaxially oriented polypropylene, cast polypropylene, polyethylene terephthalate, biaxially oriented polyethylene terephthalate, polystyrene, polystyrene-butadiene, polyamide, polyvinyl chloride, and the like. The release liner may include one or more of an oriented polymer film and a biaxially oriented polymer film. The release liner may include a release agent coated on the release surface. The release agent may include any such “low surface energy” release agent known to the art. For example, the release agent may include one or more of: a wax, a polyolefin, a silicone, an organofluorine compound, a fluoropolymer, and the like. For example, the release liner may include wax-coated paper.

In some embodiments, the pressure-sensitive adhesive may include any pressure-sensitive adhesive known to the art, e.g., one or more of: an acrylic adhesive, a rubber adhesive, a vinyl adhesive, a mastic, a silicone adhesive, a styrene block copolymer adhesive, and the like. For example, the pressure-sensitive adhesive may include one or more of: a solvent-based acrylic adhesive, a water-based acrylic adhesive, a bio-based acrylic adhesive, a butyl rubber adhesive, a natural rubber adhesive, a nitrile rubber adhesive, a polyvinyl acetate adhesive, an ethylene-vinyl acetate (EVA) adhesive, a vinyl ether adhesive, a polydimethyl siloxane rubber adhesive, a styrene-butadiene-styrene (SBS) adhesive, a styrene-ethylene/butylene-styrene (SEBS) adhesive, a styrene-ethylene/propylene (SEP) adhesive, a styrene-isoprene-styrene (SIS) adhesive, a carboxylated styrene-butadiene rubber adhesive, and the like. The pressure-sensitive adhesive may also include a tackifier. The tackifier may include one or more of: a terpene, an aromatic resin, a hydrogenated hydrocarbon resin, a terpene-phenol resin, a silicone tackifier (a tackifier configured to tackify a silicone adhesive), and the like.

In several embodiments, the process mixture may include a recycled portion of the pressure-sensitive adhesive laminate. The recycled portion of the pressure-sensitive adhesive laminate may be one or more of suspended and dissolved in the process mixture. The recycled portion of the pressure-sensitive adhesive laminate may include or more components of the pressure-sensitive adhesive laminate. For example, the recycled portion of the pressure-sensitive adhesive laminate may include portions of the facestock and the release liner delaminated from the pressure-sensitive adhesive laminate. The recycled portion of the pressure-sensitive adhesive laminate may include the pressure-sensitive adhesive at least partly dissolved in the process mixture. The recycled portion of the pressure-sensitive adhesive laminate may include one or more of: the facestock, the release liner, the pressure-sensitive adhesive, a tackifier, a release agent, an abrasion coating, a textured coating, an ultraviolet-resistant coating, a clear coating, an ink, a dye, a paint, a pigment, a scented coating, one or more decomposition products thereof, and the like.

In some embodiments, the pressure-sensitive adhesive may include one or more of a cured/curable polymeric adhesive, a hot-melt adhesive, and the like. For example, the pressure-sensitive adhesive may include one or more of: a latex; a polyurethane; an acrylic binder, e.g., an acrylic co-polymer binder; a vinyl, e.g., a polyvinyl acetate; a thermoformed polyolefin, e.g., polyethylene; copolymers thereof; blends thereof; and the like. For example, the latex may be a natural latex or a synthetic latex, for example, a synthetic latex derived from styrene-butadiene (SBS). The pressure-sensitive adhesive may be applied during manufacture of the pressure-sensitive adhesive laminate as a liquid, dispersion, or emulsion, contacted to the release liner and the facestock, e.g., latex emulsion, and cured to form the pressure-sensitive adhesive. The pressure-sensitive adhesive may be applied during manufacture of the pressure-sensitive adhesive laminate.

In several embodiments, the process mixture may include the water in a weight ratio to the pressure-sensitive adhesive laminate of one or more of about: 4:1 to 40:1; 6:1 to 35:1; 8:1 to 30:1; 10:1 to 25:1; 12.5:1 to 25:1; 12.5:1 to 20:1; and 13:1.

In various embodiments, a single-phase aqueous solution is provided. The single-phase aqueous solution may be used for recycling a pressure-sensitive adhesive laminate, as in the process mixture, the method, and the kit described herein. The single-phase aqueous solution may include water. The single-phase aqueous solution may include a surfactant composition.

In some embodiments, the single-phase aqueous solution may also include an inorganic base composition. The single-phase aqueous solution may also include a stable peroxygen composition.

In some embodiments, the surfactant composition may include at least one alkoxylated alcohol, e.g., a propoxylated alcohol or an ethoxylated alcohol. For example, the surfactant composition may include at least one alkoxylated C₆-C₁₆ alcohol, e.g., an octylphenol ethoxylate, such as Triton™-X102 (The DOW Chemical Company; Midland, Mich.). The surfactant composition may include at least one ethoxylated C₉-C₁₁ alcohol. The at least one ethoxylated C₉-C₁₁ alcohol may be provided from a mixture including between about 5% and about 10% of the ethoxylated C₉-C₁₁ alcohol. Suitable mixtures including between about 5% and about 10% of the ethoxylated C₉-C₁₁ alcohol may include, for example, LPS-T91™ (LPS Laboratories, a division of Illinois Tool Works, Inc., Tucker, Ga.). The surfactant composition may include at least one alkoxylated alcohol present in a weight percentage (w/w) with respect to the water in the single-phase aqueous solution of one or more of about: 0.025% to 1%; 0.05% to about 0.75%; 0.05% to 0.5%; 0.1% to 0.25%; 0.1% to about 0.2%; and 0.15%.

In some embodiments, the surfactant composition may include at least one alkoxylated alcohol, e.g., a propoxylated alcohol, an ethoxylated alcohol, an ethoxylated/propoxylated alcohol, or a combination thereof. For example, the surfactant composition may include an alkoxylated alcohol derived from a C₆-C₁₆ alcohol, a C₁₀-C₁₂ alcohol, a C₁₁-C₁₄ alcohol, a C₁₀-C₁₆ alcohol, a C₉-C₁₁ alcohol, a combination thereof, and the like. One or more of the C₆-C₁₆ alcohol, C₁₀-C₁₂ alcohol, C₁₁-C₁₄ alcohol, C₁₀-C₁₆ alcohol, and C₉-C₁₁ alcohol may include one or more of: a primary alcohol, a secondary alcohol, a tertiary alcohol, a linear alkyl alcohol, and a branched alkyl alcohol. One or more of the alkoxylated C₆-C₁₆ alcohol, C₁₀-C₁₂ alcohol, C₁₁-C₁₄ alcohol, C₁₀-C₁₆ alcohol, and C₉-C₁₁ alcohol may include a free hydroxyl group, i.e., one or more of the C₆-C₁₆ alcohol, C₁₀-C₁₂ alcohol, C₁₁-C₁₄ alcohol, C₁₀-C₁₆ alcohol, and C₉-C₁₁ precursor included more than one hydroxyl group.

Suitable alkoxylated alcohols may include, for example, LPS-T91™ (LPS Laboratories, a division of Illinois Tool Works, Inc., Tucker, Ga.); ETHYLAN™ 1005 SA, ETHYLAN™ 1206, ETHYLAN™ TD-60, ETHYLAN™ 324, ETHYLAN™ 954, ETHYLAN™ 1008 SA, ETHYLAN™ 992, ETHYLAN™ 995, ETHYLAN™ NS 500 K, ETHYLAN™ NS 500 LQ, ETHYLAN™ SN-120, ETHYLAN™ SN-90, ETHYLAN™ TD-1407 (AzkoNobel Surface Chemistry LLC, Chicago, Ill.); TERGITOL™ 15-S-9, TERGITOL™ 15-S-3, TERGITOL™ 15-S-5, TERGITOL™ 15-S-7, TERGITOL™ 15-S-12, TERGITOL™ 15-S-15, TERGITOL™ 15-S-20, TERGITOL™ 15-S-30, TERGITOL™ 15-S-40 (Dow Chemical Company, Midland, Mich.); TOMADOL® 1200, TOMADOL® 91-8, TOMADOL® 1-9, TOMADOL® 1-3, TOMADOL® 1-5, TOMADOL® 1-7, TOMADOL® 1-73B, TOMADOL® 23-1, TOMADOL® 23-3, TOMADOL® 23-6.5, TOMADOL® 25-12, TOMADOL® 25-3, TOMADOL® 25-7, TOMADOL® 25-9, TOMADOL® 45-13, TOMADOL® 45-7, TOMADOL® 600, TOMADOL® 900, TOMADOL® 901, TOMADOL® 902, TOMADOL® 910, TOMADOL® 91-2.5, TOMADOL® 91-6 (Air Products and Chemicals, Inc., Allentown, Pa.); octylphenol ethoxylates: TRITON™-X15, TRITON™-X35, TRITON™-X45, TRITON™-X100, TRITON™-X102, TRITON™-X114, TRITON™-X165, TRITON™-X305, TRITON™-X405, and TRITON™-X705 70 (The DOW Chemical Company; Midland, Mich.); nonylphenol ethoxylates: TERGITOL™ NP-4, TERGITOL™ NP-6, TERGITOL™ NP-7, TERGITOL™ NP-8, TERGITOL™ NP-9, TERGITOL™ NP-10, TERGITOL™ NP-11, TERGITOL™ NP-12, TERGITOL™ NP-13, TERGITOL™ NP-15, TERGITOL™ NP-30, TERGITOL™ NP-40, TERGITOL™ NP-50, TERGITOL™ NP-55, and TERGITOL™ NP-70 (The DOW Chemical Company; Midland, Mich.).

The surfactant composition may include at least one alkoxylated alcohol present in a weight percentage (w/w) with respect to the water in the single-phase aqueous solution of one or more of about: 0.025% to 1%; 0.05% to about 0.75%; 0.05% to 0.5%; 0.1% to 0.25%; 0.1% to about 0.2%; and 0.15%. The surfactant composition may include at least one alkoxylated alcohol present in a weight percentage (w/w) with respect to the water in the single-phase aqueous solution of greater than 1%. The surfactant composition may include at least one alkoxylated alcohol present in a weight percentage (w/w) with respect to the water in the single-phase aqueous solution of up to 5%.

In various embodiments, the surfactant composition may include one or more alkyl polyglycosides. The surfactant composition may include two or more alkyl polyglycosides. The surfactant composition may consist of, or may consist essentially of, the two or more alkyl polyglycosides. The surfactant composition may include at least one alkyl polyglucoside. The surfactant composition may consist of, or may consist essentially of, the at least one alkyl polyglucoside. The surfactant composition may include one or more alkyl polyglycosides. The surfactant composition may consist of, or may consist essentially of, the one or more alkyl polyglycosides. Each alkyl in the one or more alkyl polyglycosides may be independently selected from C₆-C₁₈ alkyl. Each alkyl in the one or more alkyl polyglycosides may be independently derived from a fatty alcohol derivative of coconut oil or palm kernel oil. Each alkyl in the one or more alkyl polyglycosides may be independently selected from C₈-C₁₆ alkyl. The surfactant composition may include two or more alkyl polyglucosides. The surfactant composition may consist of, or may consist essentially of, the two or more alkyl polyglucosides. The surfactant composition may include a C₈-C₁₀ alkyl polyglucoside and a C₁₀-C₁₆ alkyl polyglucoside. The surfactant composition may consist of, or may consist essentially of, the C₈-C₁₀ alkyl polyglucoside and the C₁₀-C₁₆ alkyl polyglucoside. The surfactant composition may include a weight ratio of a C₈-C₁₀ alkyl polyglucoside to a C₁₀-C₁₆ alkyl polyglucoside. The weight ratio may be, for example, between about 1:5 and about 2:3.

The surfactant composition may include two or more alkyl polyglucosides. The surfactant composition may consist of, or may consist essentially of, the two or more alkyl polyglucosides. The surfactant composition may include a C₈-C₁₀ alkyl polyglucoside and a C₁₀-C₁₆ alkyl polyglucoside. The surfactant composition may consist of, or may consist essentially of, the C₈-C₁₀ alkyl polyglucoside and the C₁₀-C₁₆ alkyl polyglucoside. The surfactant composition may include a weight ratio of a C₈-C₁₀ alkyl polyglucoside to a C₁₀-C₁₆ alkyl polyglucoside. The weight ratio may be, for example, between about 1:5 and about 2:3.

In various embodiments, the one or more alkyl polyglycosides in the surfactant composition may be present in the single-phase aqueous solution in a weight percentage (w/w) with respect to the water of about one or more of: 0.025% to 1%; 0.05% to about 0.75%; 0.05% to 0.5%; 0.1% to 0.25%; 0.1% to about 0.2%; and 0.15%, or a value or range of values based on any of the preceding, for example, from about 0.01% to about 0.5% or about 0.15%. Suitable alkyl polyglycoside compositions may include, for example, compositions sold under the tradename GLUCOPON®, e.g., GLUCOPON® 420UP, GLUCOPON® 425N, and the like. (BASF Corporation, Florham Park, N.J.). For example, GLUCOPON® 420UP may be employed in a weight percentage of from about 0.01% to about 0.5%, e.g., about 0.15%. Suitable alkyl polyglycoside compositions may include two or more alkyl polyglycosides, for example, GLUCOPON® 420UP may include caprylyl (C₈) glucoside and myristyl (C₁₄) glucoside.

In some embodiments, the surfactant composition may include at least one alkyl polyglycoside and at least one alkoxylated alcohol. The at least one alkyl polyglycoside and the at least one alkoxylated alcohol may include any of the alkyl polyglycosides and any of the alkoxylated alcohols described herein. The at least one alkyl polyglycoside and the at least one alkoxylated alcohol may be present in a weight percentage (w/w) with respect to the water in the single-phase aqueous solution in any of the values and value ranges described herein.

In various embodiments, the inorganic base composition may include one or more of: an alkali metal hydroxide, an alkaline earth metal oxide, or an alkaline earth metal hydroxide. Further, the inorganic base composition may consist of, or may consist essentially of, one or more of: the alkali metal hydroxide, the alkaline earth metal oxide, or the alkaline earth metal hydroxide. As used herein, alkali metals may include, for example, lithium, sodium, potassium, rubidium, or cesium. Alkaline earth metals may include, for example, beryllium, magnesium, calcium, strontium, or barium. For example, the inorganic base composition may include one or more of: lithium hydroxide, sodium hydroxide, potassium hydroxide, magnesium oxide, calcium oxide, magnesium hydroxide, or calcium hydroxide. The inorganic base composition may consist of, or may consist essentially of, one or more of: lithium hydroxide, sodium hydroxide, potassium hydroxide, magnesium oxide, calcium oxide, magnesium hydroxide, and calcium hydroxide. The inorganic base composition may include sodium hydroxide. The inorganic base composition may consist of, or may consist essentially of, sodium hydroxide.

In some embodiments, the inorganic base composition may be present in an amount effective to establish a desired hydroxide concentration in the single-phase aqueous solution. For example, the desired hydroxide concentration may have a molarity in moles/L (M) of about one or more of: 0.025 M to 1.25 M; 0.025 M to 1 M; 0.025 M to 0.75 M; 0.025 M to 0.625 M; 0.05 M to 0.5 M; 0.125 M to 0.4 M; 0.125 M to 0.3 M; 0.15 M to 0.25 M; and 0.19 M, or a value or range of values based on any of the preceding, for example, from about 0.025 to about 0.625, from about 0.025 to about 0.25, or about 0.19. For example, for sodium hydroxide, the inorganic base composition may be in a weight percent concentration (w/w) with respect to the water in a range of about one or more of: 0.1% to 5%, 0.1% to 4%, 0.1% to 3%, 0.1% to 2.5%, 0.2% to 2%, 0.5% to 1.6%, 0.5% to 1.2%, 0.6% to 1%, and 0.75%.

In several embodiments, the stable peroxygen composition may include an alkali metal salt of one or more of: peroxide, percarbonate, persulfate, or perborate. The stable peroxygen composition may consist of, or may consist essentially of, the alkali metal salt of one or more of: peroxide, percarbonate, persulfate, or perborate. For example, the stable peroxygen composition may include sodium percarbonate. The stable peroxygen composition may consist of, or may consist essentially of, the sodium percarbonate.

In various embodiments, the stable peroxygen composition may be present in an amount effective to provide peroxide in a molar ratio to hydroxide from the inorganic base composition. The molar ratio may about one or more of: 0.5:1 to 1.5:1; 0.55:1 to 1.4:1; 0.6:1 to 1.3:1; 0.65:1 to 1.2:1; 0.7:1 to 1.1:1; 0.8:1 to 1:1; 0.9:1 to 1.1:1; and 1:1, or a range between about any two of the preceding values, or about any of the preceding values. The stable peroxygen composition may be present in an amount effective to provide a peroxide concentration. The peroxide concentration may have a value in millimoles per liter (mM) of from about 19 mM to about 573 mM. In several embodiments, the peroxide concentration in millimoles per liter (mM) may be calculated from the hydroxide concentration based on the above molar ratios of peroxide to hydroxide.

In several embodiments, the stable peroxygen composition may include sodium percarbonate in a weight percentage (w/w) with respect to the water of one or more of about: 0.01% to 3%, 0.01% to 2.5%, 0.01% to 2%, 0.01% to 2%, 0.01% to 1.5%, 0.05% to 1.5%, 0.25% to 1.5%, 0.25% to 1.25%, 0.5% to 1.25%, 0.75% to 1.25%, and 0.75%. The stable peroxygen composition may consist of, or may consist essentially of, sodium percarbonate in a weight percentage (w/w) with respect to the water of from about 0.01% to about 1%.

The single-phase aqueous solution may include the water in a weight percent (w/w) of the single-phase aqueous solution of at least about one or more of: 92%, 93%, 94%, 95%, 96%, 97%, 98%, 98.1%, 98.25%, 98.5%, 98.75%, and 99%, for example, at least about 95% by weight of water. Further, in some embodiments, the single-phase aqueous solution may consist, or consisting essentially of: the surfactant composition and the water in a weight percent concentration (w/w) of the single-phase aqueous solution of at least about one or more of: 99%, 99.1%, 99.2%, 99.3%, 99.4%, 99.5%, 99.6%, 99.7%, 99.8%, 99.9%, 99.925%, 99.95%, and 99.975%.

In various embodiments, the single-phase aqueous solution may be characterized by a pH value of about one or more of: 10 to 14; 10.5 to 14; 11 to 14; 11.5 to 14; 12 to 14; and 12.5 to 13.5.

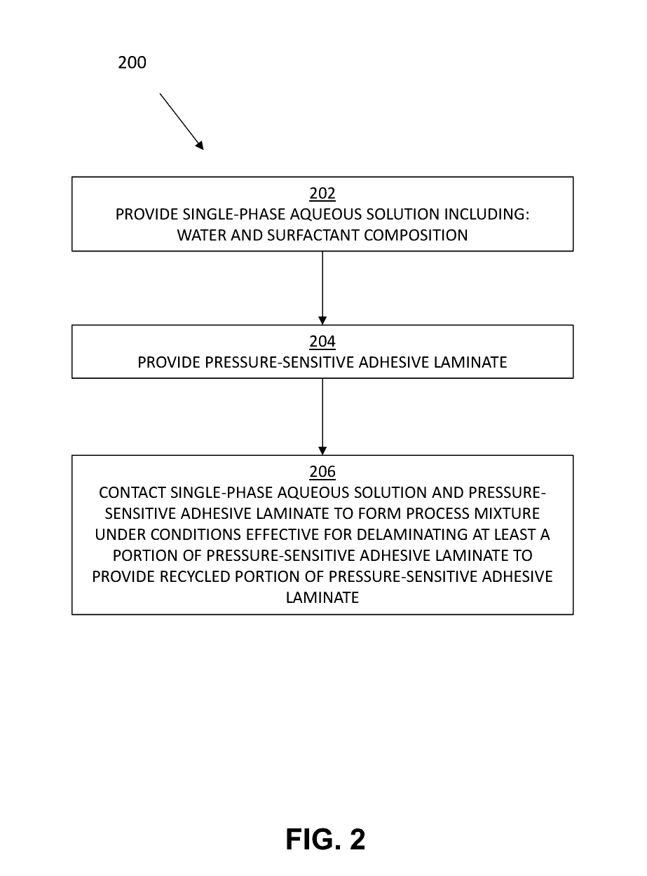

In various embodiments, a method 200 is provided for recycling a pressure-sensitive adhesive laminate using a single-phase aqueous solution. FIG. 2 depicts a flow chart of method 200. The method may include 202 providing a single-phase aqueous solution. The single-phase aqueous solution may include water. The single-phase aqueous solution may include a surfactant composition. The method may include 204 providing the pressure-sensitive adhesive laminate. The method may include 206 contacting the single-phase aqueous solution and the pressure-sensitive adhesive laminate to form a process mixture under conditions effective for delaminating at least a portion of the pressure-sensitive adhesive laminate to provide a recycled portion of the pressure-sensitive adhesive laminate.

The pressure-sensitive adhesive laminate may include any pressure-sensitive laminate described herein. For example, the pressure-sensitive adhesive laminate may include a facestock. The facestock may include a label surface and an adhesion surface. The pressure-sensitive adhesive laminate may include a release liner. The release liner may include a release surface. The pressure-sensitive adhesive laminate may include a pressure-sensitive adhesive coated on the adhesion surface of the facestock. The release surface of the release liner may be laminated to the adhesion surface of the facestock through the pressure-sensitive adhesive to form the pressure-sensitive adhesive laminate.

In several embodiments, the facestock may include one or more of: a polymer film, a metallized polymer film, a metal foil, a paper, a resin-bonded paper, a coated paper, a synthetic paper, a flashspun fabric, a polymer film-paper laminate, a metallized paper, an elastomeric foam, a woven textile, a nonwoven textile, and the like. The facestock may include combinations thereof, e.g., a polymer film combined with a textile, a metallized paper combined with a polymer film, and the like. The facestock may include a layer of one or more of: cellulose acetate, cellulose triacetate, cellulose acetobutyrate, cellulose hydrate, polyethylene, polypropylene, polyethylene/polystyrene, oriented polypropylene, biaxially oriented polypropylene, cast polypropylene, polyethylene terephthalate, biaxially oriented polyethylene terephthalate, polystyrene, polystyrene-butadiene, polyamide, polyamide/aluminum, polyvinyl chloride, and the like. The facestock may include one or more of an oriented polymer film and a biaxially oriented polymer film. The facestock may include a synthetic paper formed of bonded polyolefin fibers, e.g., the synthetic paper formed of bonded polypropylene fibers sold under the tradename TYVEK® (DuPont, Wilmington, Del.). For example, the facestock may include a synthetic paper formed of bonded polypropylene fibers.

In various embodiments, the facestock may include a primer coating on the adhesion surface. The primer coating may be configured to facilitate adhesion of the pressure-sensitive adhesive to the adhesion surface of the facestock. The primer coating may be any such coating known to the art.

In some embodiments, the label surface of the facestock may include or may be in contact with one or more of: an abrasion coating, a textured coating, an ultraviolet-resistant coating, a clear coating, an ink, a dye, a paint, a pigment, and a scented coating.

In several embodiments, the release liner and the facestock may each include a layer of the same material, e.g., the release liner and the facestock may each include polyethylene terephthalate. In some embodiments, the release liner and the facestock may each include a layer of different material, e.g., the facestock may include a synthetic paper formed of bonded polypropylene fibers and the release liner may include polyethylene terephthalate.

In various embodiments, the release liner may include one or more of: a polymer film, a paper, a resin-bonded paper, a coated paper, a synthetic paper, a polymer film-paper laminate, combinations thereof; and the like. For example, the release liner may include a polymer film of one or more of: a polyester, a polyolefin, a cellulose derivative, a polystyrene, a polyvinyl, a polyamide, and the like. For example, the release liner may include a layer of one or more of: cellulose acetate, cellulose triacetate, cellulose acetobutyrate, cellulose hydrate, polyethylene, low density polyethylene, high density polyethylene, polypropylene, polyethylene/polystyrene, oriented polypropylene, biaxially oriented polypropylene, cast polypropylene, polyethylene terephthalate, biaxially oriented polyethylene terephthalate, polystyrene, polystyrene-butadiene, polyamide, polyvinyl chloride, and the like. The release liner may include one or more of an oriented polymer film and a biaxially oriented polymer film. The release liner may include a release agent coated on the release surface. The release agent may include any such “low surface energy” release agent known to the art. For example, the release agent may include one or more of: a wax, a polyolefin, a silicone, an organofluorine compound, a fluoropolymer, and the like. For example, the release liner may include wax-coated paper.

In some embodiments, the pressure-sensitive adhesive may include any pressure-sensitive adhesive known to the art, e.g., one or more of: an acrylic adhesive, a rubber adhesive, a vinyl adhesive, a mastic, a silicone adhesive, a styrene block copolymer adhesive, and the like. For example, the pressure-sensitive adhesive may include one or more of: a solvent-based acrylic adhesive, a water-based acrylic adhesive, a bio-based acrylic adhesive, a butyl rubber adhesive, a natural rubber adhesive, a nitrile rubber adhesive, a polyvinyl acetate adhesive, an ethylene-vinyl acetate (EVA) adhesive, a vinyl ether adhesive, a polydimethyl siloxane rubber adhesive, a styrene-butadiene-styrene (SBS) adhesive, a styrene-ethylene/butylene-styrene (SEBS) adhesive, a styrene-ethylene/propylene (SEP) adhesive, a styrene-isoprene-styrene (SIS) adhesive, a carboxylated styrene-butadiene rubber adhesive, and the like. The pressure-sensitive adhesive may also include a tackifier. The tackifier may include one or more of: a terpene, an aromatic resin, a hydrogenated hydrocarbon resin, a terpene-phenol resin, a silicone tackifier (a tackifier configured to tackify a silicone adhesive), and the like.

In some embodiments, the process mixture may include a recycled portion of the pressure-sensitive adhesive laminate. The recycled portion of the pressure-sensitive adhesive laminate may be one or more of suspended and dissolved in the process mixture. Providing the recycled portion of the fibrous surface may include one or more of suspending and dissolving the recycled portion in the process mixture. The recycled portion of the pressure-sensitive adhesive laminate may include one or more of: portions of the facestock and the release liner delaminated from the pressure-sensitive adhesive laminate. The recycled portion of the pressure-sensitive adhesive laminate may include the pressure-sensitive adhesive at least partly dissolved in the process mixture. The recycled portion of the pressure-sensitive adhesive laminate may include one or more of: the facestock, the release liner, the pressure-sensitive adhesive, a tackifier, a release agent, an abrasion coating, a textured coating, an ultraviolet-resistant coating, a clear coating, an ink, a dye, a paint, a pigment, a scented coating, a decomposition product thereof such as may be produced by action of the single-phase aqueous solution on the pressure-sensitive adhesive laminate, and the like. Providing the recycled portion of the pressure-sensitive adhesive laminate may include at least partly uncoupling the recycled portion of the pressure-sensitive adhesive laminate from the pressure-sensitive adhesive laminate.

In several embodiments, the method may include one or more of separating and recovering the recycled portion of the pressure-sensitive adhesive laminate from the process mixture. Such separating and recovering may be performed by any suitable method such as filtering, drying, centrifuging, float-sink separation, pelletizing, and the like. For example, the method may include pelletizing at least a portion of the recycled portion of the pressure-sensitive adhesive laminate.

In various embodiments, the conditions effective to remove a portion of the one or more coatings from the pressure-sensitive adhesive laminate may include heating the process mixture. The process mixture may be heated at a temperature of about one or more of: 50° C. to 100° C.; 60° C. to 100° C.; 60° C. to 95° C.; 60° C. to 90° C.; 60° C. to 85° C.; and 65° C. to 85° C.; 80° C. to 85° C.; 82° C., and the like.

In various embodiments, the conditions effective to remove a portion of the one or more coatings from the pressure-sensitive adhesive laminate may include agitating the process mixture, e.g., by stirring, shaking, tumbling, sonication, and the like, e.g., by stirring using a rotor. The method may include stirring the process mixture at a rotational speed of at least about one or more of: 250 RPM to 2000 RPM, 500 RPM to 1750 RPM, 750 RPM to 1500 RPM, 750 RPM to 1250 RPM, 800 RPM to 1200 RPM, 900 RPM to 1100 RPM, 1000 RPM, and the like.

In various embodiments, the method may further include recovering the recycled portion of the pressure-sensitive adhesive laminate, e.g., by filtering, decanting, centrifugation, drying, or any other conventional technique. The method may further include recovering at least a portion of the single-phase aqueous solution after providing the recycled portion of the pressure-sensitive adhesive laminate.

In various embodiments, the conditions effective to provide the recycled portion of the pressure-sensitive adhesive laminate may include batch operation. The conditions effective to provide the recycled portion of the pressure-sensitive adhesive laminate may include continuous operation. In some embodiments, the method may include removing a percentage of the pressure-sensitive adhesive from the pressure-sensitive adhesive laminate; the percentage may be at least about one or more of: 20%, 30%, 40%, 50%, 60%, 70%, 80%, 90%, 91%, 92%, 93%, 94%, 95%, 96%, 97%, 98%, 99%, 99.5%, 99.6%, 99.7%, 99.8%, 99.9%, and 100%.

In several embodiments, the method may include heating and agitating the process mixture in a first step. The first step may be effective for delaminating at least the portion of the pressure-sensitive adhesive laminate. The first step may be effective for removing at least a first portion of the pressure-sensitive adhesive from the pressure-sensitive adhesive laminate. The method may include replacing at least a portion of the single-phase aqueous solution from the process mixture with a fresh portion of the single-phase aqueous solution. The method may include heating and agitating the process mixture comprising the fresh portion of the single-phase aqueous solution in a second step. The second step may be effective for delaminating a further portion of the pressure-sensitive adhesive laminate. The second step may be effective for removing at least a second portion of the pressure-sensitive adhesive from the pressure-sensitive adhesive laminate. In some embodiments, the first portion of the pressure-sensitive adhesive may be a percentage of the pressure-sensitive adhesive in the pressure-sensitive adhesive laminate; the percentage may be at least about one or more of: 20%, 30%, 40%, 50%, 60%, 70%, 80%, and 90%. The first and second portions of the pressure-sensitive adhesive may together be a combined percentage of the pressure-sensitive adhesive in the pressure-sensitive adhesive laminate. The combined percentage may be at least about one or more of: 50%, 60%, 70%, 80%, 90%, 91%, 92%, 93%, 94%, 95%, 96%, 97%, 98%, 99%, 99.5%, 99.6%, 99.7%, 99.8%, 99.9%, and 100%.

In several embodiments, the pressure-sensitive adhesive laminate may include printing on the label surface of the facestock. The method may include removing a percentage of the printing on the label surface of the facestock. The printing may include one or more of an ink, a dye, a paint, and a pigment. The percentage of the printing on the label surface of the facestock removed may be at least about one or more of: 20%, 30%, 40%, 50%, 60%, 70%, 80%, 90%, 91%, 92%, 93%, 94%, 95%, 96%, 97%, 98%, 99%, 99.5%, 99.6%, 99.7%, 99.8%, 99.9%, and 100%.

In some embodiments, the method may include providing the water in a weight ratio to the pressure-sensitive adhesive laminate of one or more of about: 4:1 to 40:1; 6:1 to 35:1; 8:1 to 30:1; 10:1 to 25:1; 12.5:1 to 25:1; 12.5:1 to 20:1; and 13:1.

The method may include providing the single-phase aqueous solution according to any of the features or values for the single-phase aqueous solution as described herein. The method may include preparing the single-phase aqueous solution according to any of the features or values for the single-phase aqueous solution as described herein. The method may include providing the process mixture according to any of the features or values for the process mixture as described herein. The method may include preparing the process mixture according to any of the features or values for process mixture as described herein.

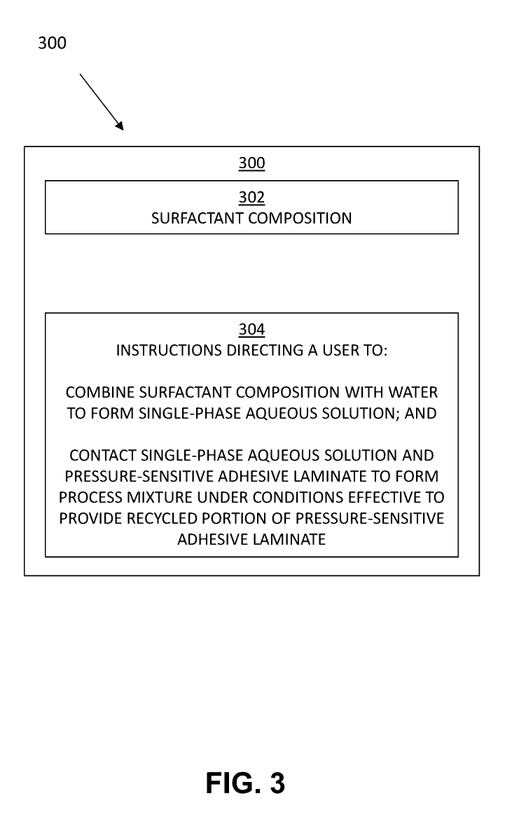

In various embodiments, a kit 300 is provided. FIG. 3 depicts a block diagram of kit 300. Kit 300 may be for recycling a pressure-sensitive adhesive laminate. The kit may include 302 a surfactant composition. The kit may include instructions 304. The instructions may direct a user to combine the surfactant composition with water to form the single-phase aqueous solution. The instructions may direct the user to contact the single-phase aqueous solution and the pressure-sensitive adhesive laminate to form a process mixture under conditions effective to provide a recycled portion of the pressure-sensitive adhesive laminate.

The instructions may direct the user to provide the pressure-sensitive adhesive laminate. The pressure-sensitive adhesive laminate may be any pressure-sensitive adhesive laminate described herein. For example, the pressure-sensitive adhesive laminate may include a facestock. The facestock may include a label surface and an adhesion surface. The pressure-sensitive adhesive laminate may include a release liner. The release liner may include a release surface. The pressure-sensitive adhesive laminate may include a pressure-sensitive adhesive coated on the adhesion surface of the facestock. The release surface of the release liner may be laminated to the adhesion surface of the facestock through the pressure-sensitive adhesive to form the pressure-sensitive adhesive laminate.

In some embodiments, the kit may include one or more of: an inorganic base composition, a stable peroxygen composition, and the surfactant composition. The instructions may direct a user to combine one or more of the inorganic base composition, the stable peroxygen composition, and the surfactant composition with water to form the single-phase aqueous solution.

In various embodiments, the kit may include a mixture of the surfactant composition together with water in the form of an aqueous concentrate. The instructions may direct the user to form a process mixture by contacting the single-phase aqueous solution to the pressure-sensitive adhesive laminate. The instructions may direct the user to provide the single-phase aqueous solution according to any of the features or values for the single-phase aqueous solution as described herein. The instructions may direct the user to prepare the single-phase aqueous solution according to any of the features or values for the single-phase aqueous solution as described herein. The instructions may direct the user to provide the process mixture according to any of the features or values for the process mixture as described herein. The instructions may direct the user to prepare the process mixture according to any of the features or values for the process mixture as described herein. The instructions may direct the user to recycle the pressure-sensitive adhesive laminate according to any of the methods described herein.

In various embodiments, a recycled portion of a pressure-sensitive adhesive laminate is provided. The recycled portion of the pressure-sensitive adhesive laminate may include one or more of: a facestock, a release liner, a pressure-sensitive adhesive, a tackifier, a release agent, an abrasion coating, a textured coating, an ultraviolet-resistant coating, a clear coating, an ink, a dye, a paint, a pigment, a scented coating, and a decomposition product thereof. The recycled portion of the pressure-sensitive adhesive laminate may be produced by any method described herein. The recycled portion of the pressure-sensitive adhesive laminate may be produced using any process mixture described herein. The recycled portion of the pressure-sensitive adhesive laminate may be produced using any single-phase aqueous solution described herein. The recycled portion of the pressure-sensitive adhesive laminate may be produced using any kit described herein.

### Examples

### Example 1: Two-Step Recycling of Pressure-Sensitive Adhesive Laminate

To a reaction vessel equipped with a mechanical stirring blade was added 4.54 kg of a single phase aqueous solution of 0.75% (w/w) sodium hydroxide, 0.15% (w/w) GLUCOPON®, and 1.0% (w/w) sodium percarbonate. About 340 g of ground, ink-printed, pressure-sensitive adhesive laminate scrap (Avery Dennison, Glendale, Calif.) was added to the reaction vessel and the resulting process mixture was stirred (1000 RPM) at about 74° C. for 7 h. The aqueous solution was removed by filtration and the partly recycled pressure-sensitive adhesive laminate was washed with water. The resulting intermediate material was observed to be substantially delaminated, greater than about 75% free of the pressure-sensitive adhesive, and about 40% free of the ink coating.

The intermediate material was contacted with a fresh portion of 4.54 kg of the single-phase aqueous solution including 0.75% (w/w) sodium hydroxide, 0.15% (w/w) GLUCOPON®, and 1.0% (w/w) sodium percarbonate. After being stirred (1000 RPM) at 74° C. for 7 h, the process mixture was filtered, and the laminate material was washed with water. The resulting final recycled portion of the pressure-sensitive adhesive laminate was observed to be delaminated, 100% free of the pressure-sensitive adhesive, and greater than about 98% free of the ink coating.

### Example 2: Three-Step Recycling of Pressure-Sensitive Adhesive Film Roll

To a reaction vessel equipped with a mechanical stirring blade was added 5.44 kg of water; 2.0% (w/w) sodium hydroxide, 2.0% (w/w) gluconic acid, 0.1% (w/w) Triton™-X102, (The DOW Chemical Company; Midland, Mich.), and 2.0% (w/w) sodium percarbonate. About 227 g of granulated (<5 mm), ink-printed, pressure-sensitive adhesive film roll scrap (Avery Dennison, Glendale, Calif.) was added to the reaction vessel and the resulting process mixture was stirred (1200 RPM) at about 82.2° C. for 7 h. The aqueous solution was removed by filtration and the partly recycled pressure-sensitive adhesive laminate was washed with water. The resulting intermediate material was observed to be substantially delaminated, greater than about 55% free of the pressure-sensitive adhesive, and about ˜50% free of the ink coating.

The intermediate material was contacted with a fresh portion of 5.44 kg of water, 2.0% (w/w) sodium hydroxide, 2.0% (w/w) gluconic acid, 0.1% (w/w) Triton™-X102, and 2.0% (w/w) sodium percarbonate. After being stirred (1200 RPM) at 82° C. for 7 h, the process mixture was filtered, and the laminate material was washed with water. The resulting second intermediate material was observed to be delaminated, ˜80% free of the pressure-sensitive adhesive, and greater than about 70% free of the ink coating.

The second intermediate material was contacted with 5.44 kg of water and 1.0% (w/w) LPS-T91™ (LPS Laboratories, a division of Illinois Tool Works, Inc., Tucker, Ga.). After being stirred (1200RPM) at 82° C. for 7 h, the process mixture was filtered, and the laminate material was washed with water. The resulting final recycled portion of the pressure-sensitive adhesive film roll was observed to be delaminated, >99% free of the pressure-sensitive adhesive, and greater than about 99.4% free of the ink coating.

The final recycled portion was further subjected to a float-sink tank to separate the PET and the PP films. The final fluff is added into the float sink tank with suitable wetting agent to separate the material based on density. PP fluff is separated from the top as float material and PET is collected as heavies from Float sink tank.

### Prophetic Example 3: One-Step Recycling of Pressure-Sensitive Adhesive Laminate

To a reaction vessel equipped with a mechanical stirring blade may be added 9.0 kg of water including 0.75%-1.5% (w/w) sodium hydroxide, 0.15%-0.30% (w/w) GLUCOPON®, and 1.0%-2.0% (w/w) sodium percarbonate. About 340 g of ground, ink-printed, pressure-sensitive adhesive laminate scrap (Avery Dennison, Glendale, Calif.) may be added to the reaction vessel and the resulting process mixture may be stirred (1000 RPM) at about 74° C. for 7 h-14 h. The aqueous solution may be removed by filtration and the recycled portion of the pressure-sensitive adhesive laminate may be washed with water. The resulting final recycled portion of the pressure-sensitive adhesive laminate may be observed to be at least partly delaminated, at least partly free of pressure-sensitive adhesive, and at least partly free of ink coating.

### Prophetic Example 4: Two-Step Recycling of Pressure-Sensitive Adhesive Laminate

To a reaction vessel equipped with a mechanical stirring blade may be added 4.54 kg of a single phase aqueous solution of 0.75% (w/w) sodium hydroxide and 0.15% (w/w) GLUCOPON®. About 340 g of ground, ink-printed pressure-sensitive adhesive laminate scrap (Avery Dennison, Glendale, Calif.) may be added to the reaction vessel and the resulting process mixture may be stirred (1000 RPM) at about 74° C. for 7 h. The aqueous solution may be removed by filtration and the partly recycled pressure-sensitive adhesive laminate may be washed with water. The resulting intermediate recycled portion of the pressure-sensitive adhesive laminate may be observed to be at least partly delaminated, at least partly free of pressure-sensitive adhesive, and at least partly free of ink coating.

The intermediate material may be contacted with a fresh portion of 4.54 kg of the single-phase aqueous solution including 0.75% (w/w) sodium hydroxide and 0.15% (w/w) GLUCOPON®. The resulting process mixture may be stirred (1000 RPM) at 74° C. for 7 h, filtered, and the laminate material may be washed with water. The resulting final recycled portion of the pressure-sensitive adhesive laminate may be observed to be significantly delaminated, significantly free of pressure-sensitive adhesive, and significantly free of ink coating.

### Prophetic Example 5: One-Step Recycling of Pressure-Sensitive Adhesive Laminate

To a reaction vessel equipped with a mechanical stirring blade may be added 9.0 kg of water including 0.75%-1.5% (w/w) sodium hydroxide and 0.15%-0.30% (w/w) GLUCOPON®. About 340 g of ground, ink-printed, pressure-sensitive adhesive laminate scrap (Avery Dennison, Glendale, Calif.) may be added to the reaction vessel and the resulting process mixture may be stirred (1000 RPM) at about 74° C. for 7 h-14 h. The aqueous solution may be removed by filtration and the recycled portion of the pressure-sensitive adhesive laminate may be washed with water. The resulting final recycled portion of the pressure-sensitive adhesive laminate may be observed to be at least partly delaminated, at least partly free of pressure-sensitive adhesive, and at least partly free of ink coating.

### Prophetic Example 6: Two-Step Recycling of Pressure-Sensitive Adhesive Laminate

To a reaction vessel equipped with a mechanical stirring blade may be added 4.54 kg of a single phase aqueous solution of 0.75% (w/w) sodium hydroxide and 1.0% (w/w) sodium percarbonate. About 340 g of ground, ink-printed pressure-sensitive adhesive laminate scrap (Avery Dennison, Glendale, Calif.) may be added to the reaction vessel and the resulting process mixture may be stirred (1000 RPM) at about 74° C. for 7 h. The aqueous solution may be removed by filtration and the partly recycled pressure-sensitive adhesive laminate may be washed with water. The resulting intermediate recycled portion of the pressure-sensitive adhesive laminate may be observed to be at least partly delaminated, at least partly free of pressure-sensitive adhesive, and at least partly free of ink coating.

The intermediate material may be contacted with a fresh portion of 4.54 kg of the single-phase aqueous solution including 0.75% (w/w) sodium hydroxide and 1.0% (w/w) sodium percarbonate. The resulting process mixture may be stirred (1000 RPM) at 74° C. for 7 h, filtered, and the laminate material may be washed with water. The resulting final recycled portion of the pressure-sensitive adhesive laminate may be observed to be significantly delaminated, significantly free of pressure-sensitive adhesive, and significantly free of ink coating.

### Prophetic Example 7: One-Step Recycling of Pressure-Sensitive Adhesive Laminate

To a reaction vessel equipped with a mechanical stirring blade may be added 9.0 kg of water including 0.75%-1.5% (w/w) sodium hydroxide and 1.0%-2.0% (w/w) sodium percarbonate. About 340 g of ground, ink-printed, pressure-sensitive adhesive laminate scrap (Avery Dennison, Glendale, Calif.) may be added to the reaction vessel and the resulting process mixture may be stirred (1000 RPM) at about 74° C. for 7 h-14 h. The aqueous solution may be removed by filtration and the recycled portion of the pressure-sensitive adhesive laminate may be washed with water. The resulting final recycled portion of the pressure-sensitive adhesive laminate may be observed to be at least partly delaminated, at least partly free of pressure-sensitive adhesive, and at least partly free of ink coating.

### Prophetic Example 8: Two-Step Recycling of Pressure-Sensitive Adhesive Laminate

To a reaction vessel equipped with a mechanical stirring blade may be added 4.54 kg of a single phase aqueous solution of 0.15% (w/w) GLUCOPON®. About 340 g of ground, ink-printed pressure-sensitive adhesive laminate scrap (Avery Dennison, Glendale, Calif.) may be added to the reaction vessel and the resulting process mixture may be stirred (1000 RPM) at about 74° C. for 7 h. The aqueous solution may be removed by filtration and the partly recycled pressure-sensitive adhesive laminate may be washed with water. The resulting intermediate recycled portion of the pressure-sensitive adhesive laminate may be observed to be at least partly delaminated, at least partly free of pressure-sensitive adhesive, and at least partly free of ink coating.

The intermediate material may be contacted with a fresh portion of 4.54 kg of the single-phase aqueous solution including 0.15% (w/w) GLUCOPON®. The resulting process mixture may be stirred (1000 RPM) at 74° C. for 7 h, filtered, and the laminate material may be washed with water. The resulting final recycled portion of the pressure-sensitive adhesive laminate may be observed to be significantly delaminated, significantly free of pressure-sensitive adhesive, and significantly free of ink coating.

### Prophetic Example 9: One-Step Recycling of Pressure-Sensitive Adhesive Laminate

To a reaction vessel equipped with a mechanical stirring blade may be added 9.0 kg of water including 0.15%-0.30% (w/w) GLUCOPON®. About 340 g of ground, ink-printed, pressure-sensitive adhesive laminate scrap (Avery Dennison, Glendale, Calif.) may be added to the reaction vessel and the resulting process mixture may be stirred (1000 RPM) at about 74° C. for 7 h-14 h. The aqueous solution may be removed by filtration and the recycled portion of the pressure-sensitive adhesive laminate may be washed with water. The resulting final recycled portion of the pressure-sensitive adhesive laminate may be observed to be at least partly delaminated, at least partly free of pressure-sensitive adhesive, and at least partly free of ink coating.

To the extent that the term “includes” or “including” is used in the specification or the claims, it is intended to be inclusive in a manner similar to the term “comprising” as that term is interpreted when employed as a transitional word in a claim. Various embodiments herein may recite the term “including,” or, in the claims, the term “comprising,” and their grammatical variants. For each such embodiment, corresponding additional embodiments are explicitly contemplated where the term “comprising” is replaced with “consisting essentially of” and “consisting of.” For example, the single-phase aqueous solution may consist essentially of: the water and the surfactant composition. Further, for example, the single-phase aqueous solution may consist of: the water and the surfactant composition.

Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “selectively” is used in the specification or the claims, it is intended to refer to a condition of a component wherein a user of the apparatus may activate or deactivate the feature or function of the component as is necessary or desired in use of the apparatus. To the extent that the terms “operatively coupled” or “operatively connected” are used in the specification or the claims, it is intended to mean that the identified components are connected in a way to perform a designated function. To the extent that the term “substantially” is used in the specification or the claims, it is intended to mean that the identified components have the relation or qualities indicated with degree of error as would be acceptable in the subject industry.

As used in the specification and the claims, the singular forms “a,” “an,” and “the” include the plural unless the singular is expressly specified. For example, reference to “a compound” may include a mixture of two or more compounds, as well as a single compound.

As used herein, the term “about” in conjunction with a number is intended to include ±10% of the number. In other words, “about 10” may mean from 9 to 11.

As used herein, the terms “optional” and “optionally” mean that the subsequently described circumstance may or may not occur, so that the description includes instances where the circumstance occurs and instances where it does not.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

As used herein, “substituted” refers to an organic group as defined below (e.g., an alkyl group) in which one or more bonds to a hydrogen atom contained therein may be replaced by a bond to non-hydrogen or non-carbon atoms. Substituted groups also include groups in which one or more bonds to a carbon(s) or hydrogen(s) atom may be replaced by one or more bonds, including double or triple bonds, to a heteroatom. A substituted group may be substituted with one or more substituents, unless otherwise specified. In some embodiments, a substituted group may be substituted with 1, 2, 3, 4, 5, or 6 substituents. Examples of substituent groups include: halogens (i.e., F, Cl, Br, and I); hydroxyls; alkoxy, alkenoxy, aryloxy, aralkyloxy, heterocyclyloxy, and heterocyclylalkoxy groups; carbonyls (oxo); carboxyls; esters; urethanes; oximes; hydroxylamines; alkoxyamines; aralkoxyamines; thiols; sulfides; sulfoxides; sulfones; sulfonyls; sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; or nitriles (i.e., CN). A “per”-substituted compound or group is a compound or group having all or substantially all substitutable positions substituted with the indicated substituent. For example, 1,6-diiodo perfluoro hexane indicates a compound of formula C₆F₁₂I₂, where all the substitutable hydrogens have been replaced with fluorine atoms.

Substituted ring groups such as substituted cycloalkyl, aryl, heterocyclyl and heteroaryl groups also include rings and ring systems in which a bond to a hydrogen atom may be replaced with a bond to a carbon atom. Substituted cycloalkyl, aryl, heterocyclyl and heteroaryl groups may also be substituted with substituted or unsubstituted alkyl, alkenyl, and alkynyl groups as defined below.

Alkyl groups include straight chain and branched chain alkyl groups having from 1 to 12 carbon atoms, and typically from 1 to 10 carbons or, in some examples, from 1 to 8, 1 to 6, or 1 to 4 carbon atoms. Examples of straight chain alkyl groups include groups such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, tert-butyl, neopentyl, isopentyl, and 2,2-dimethylpropyl groups. Representative substituted alkyl groups may be substituted one or more times with substituents such as those listed above and include, without limitation, haloalkyl (e.g., trifluoromethyl), hydroxyalkyl, thioalkyl, aminoalkyl, alkylaminoalkyl, dialkylaminoalkyl, alkoxyalkyl, or carboxyalkyl.

Cycloalkyl groups include mono-, bi- or tricyclic alkyl groups having from 3 to 12 carbon atoms in the ring(s), or, in some embodiments, 3 to 10, 3 to 8, or 3 to 4, 5, or 6 carbon atoms. Exemplary monocyclic cycloalkyl groups include, but are not limited to, cyclopropyl, cyclobutyl, cyclopentyl, cyclohexyl, cycloheptyl, and cyclooctyl groups. In some embodiments, the cycloalkyl group has 3 to 8 ring members, whereas in other embodiments, the number of ring carbon atoms ranges from 3 to 5, 3 to 6, or 3 to 7. Bi- and tricyclic ring systems include both bridged cycloalkyl groups and fused rings, such as, but not limited to, bicyclo[2.1.1]hexane, adamantyl, or decalinyl. Substituted cycloalkyl groups may be substituted one or more times with non-hydrogen and non-carbon groups as defined above. However, substituted cycloalkyl groups also include rings that may be substituted with straight or branched chain alkyl groups as defined above. Representative substituted cycloalkyl groups may be mono-substituted or substituted more than once, such as, but not limited to, 2,2-, 2,3-, 2,4-2,5- or 2,6-disubstituted cyclohexyl groups, which may be substituted with substituents such as those listed above.

Aryl groups may be cyclic aromatic hydrocarbons that do not contain heteroatoms. Aryl groups herein include monocyclic, bicyclic and tricyclic ring systems. Aryl groups include, but are not limited to, phenyl, azulenyl, heptalenyl, biphenyl, fluorenyl, phenanthrenyl, anthracenyl, indenyl, indanyl, pentalenyl, and naphthyl groups. In some embodiments, aryl groups contain 6-14 carbons, and in others from 6 to 12 or even 6-10 carbon atoms in the ring portions of the groups. In some embodiments, the aryl groups may be phenyl or naphthyl. Although the phrase “aryl groups” may include groups containing fused rings, such as fused aromatic-aliphatic ring systems (e.g., indanyl or tetrahydronaphthyl), “aryl groups” does not include aryl groups that have other groups, such as alkyl or halo groups, bonded to one of the ring members. Rather, groups such as tolyl may be referred to as substituted aryl groups. Representative substituted aryl groups may be mono-substituted or substituted more than once. For example, monosubstituted aryl groups include, but are not limited to, 2-, 3-, 4-, 5-, or 6-substituted phenyl or naphthyl, which may be substituted with substituents such as those above.

Aralkyl groups may be alkyl groups as defined above in which a hydrogen or carbon bond of an alkyl group may be replaced with a bond to an aryl group as defined above. In some embodiments, aralkyl groups contain 7 to 16 carbon atoms, 7 to 14 carbon atoms, or 7 to 10 carbon atoms. Substituted aralkyl groups may be substituted at the alkyl, the aryl or both the alkyl and aryl portions of the group. Representative aralkyl groups include but are not limited to benzyl and phenethyl groups and fused (cycloalkylaryl)alkyl groups such as 4-indanylethyl. Substituted aralkyls may be substituted one or more times with substituents as listed above.

Groups described herein having two or more points of attachment (i.e., divalent, trivalent, or polyvalent) within the compound of the technology may be designated by use of the suffix, “ene.” For example, divalent alkyl groups may be alkylene groups, divalent aryl groups may be arylene groups, divalent heteroaryl groups may be heteroarylene groups, and so forth. In particular, certain polymers may be described by use of the suffix “ene” in conjunction with a term describing the polymer repeat unit.

Alkoxy groups may be hydroxyl groups (—OH) in which the bond to the hydrogen atom may be replaced by a bond to a carbon atom of a substituted or unsubstituted alkyl group as defined above. Examples of linear alkoxy groups include, but are not limited to, methoxy, ethoxy, propoxy, butoxy, pentoxy, or hexoxy. Examples of branched alkoxy groups include, but are not limited to, isopropoxy, sec-butoxy, tert-butoxy, isopentoxy, or isohexoxy. Examples of cycloalkoxy groups include, but are not limited to, cyclopropyloxy, cyclobutyloxy, cyclopentyloxy, or cyclohexyloxy. Representative substituted alkoxy groups may be substituted one or more times with substituents such as those listed above.

The various aspects and embodiments disclosed herein are for purposes of illustration and are not intended to be limiting, with the true scope and spirit being indicated by the following claims.

1. A method for recycling a pressure-sensitive adhesive laminate using a single-phase aqueous solution, comprising:
providing the single-phase aqueous solution comprising: water and a surfactant composition;
providing the pressure-sensitive adhesive laminate comprising:
a facestock, the facestock comprising a label surface and an adhesion surface;
a release liner, the release liner comprising a release surface;
a pressure-sensitive adhesive coated on the adhesion surface of the facestock, the release surface of the release liner being laminated to the adhesion surface of the facestock through the pressure-sensitive adhesive to form the pressure-sensitive adhesive laminate; and
contacting the single-phase aqueous solution and the pressure-sensitive adhesive laminate to form a process mixture under conditions effective for delaminating at least a portion of the pressure-sensitive adhesive laminate to provide a recycled portion of the pressure-sensitive adhesive laminate.

2. The method of claim 1, further comprising one or more of shredding and cutting the pressure-sensitive adhesive laminate to form a plurality of pieces;
the one or more of shredding and cutting being performed on the pressure-sensitive adhesive laminate in the form of one or more of: a sheet, a roll, a remnant, a sample, a labeling scrap, and a manufacturing scrap.

3. The method of claim 1, one or more of the facestock and the release liner comprising one or more of:
fibers of one or more of: a polymer film, a metallized polymer film, a metal foil, a paper, a resin-bonded paper, a coated paper, a synthetic paper, a flashspun fabric, a polymer film-paper laminate, a metallized paper, an elastomeric foam, a woven textile, a nonwoven textile, and combinations thereof; and
a layer of one or more of: cellulose acetate, cellulose triacetate, cellulose acetobutyrate, cellulose hydrate, polyethylene, polypropylene, polyethylene/polystyrene, oriented polypropylene, biaxially oriented polypropylene, cast polypropylene, polyethylene terephthalate, biaxially oriented polyethylene terephthalate, polystyrene, polystyrene-butadiene, polyamide, polyamide/aluminum, and polyvinyl chloride.

4. The method of claim 1, one or more of:
the facestock comprises a primer coating on the adhesion surface, the primer coating being configured to facilitate adhesion of the pressure-sensitive adhesive to the adhesion surface of the facestock;
the label surface of the facestock comprises or is in contact with one or more of: an abrasion coating, a textured coating, an ultraviolet-resistant coating, a clear coating, an ink, a dye, a paint, a pigment, and a scented coating; and
the release liner comprises a release agent coated on the release surface, the release agent comprising one or more of: a wax, a polyolefin, a silicone, an organofluorine compound, and a fluoropolymer.

5. The method of claim 1, the pressure-sensitive adhesive comprising one or more of:
one or more of: an acrylic adhesive, a rubber adhesive, a vinyl adhesive, a mastic, a silicone adhesive, and a styrene block copolymer adhesive, a solvent-based acrylic adhesive, a water-based acrylic adhesive, a bio-based acrylic adhesive, a butyl rubber adhesive, a natural rubber adhesive, a nitrile rubber adhesive, a polyvinyl acetate adhesive, an ethylene-vinyl acetate (EVA) adhesive, a vinyl ether adhesive, a polydimethyl siloxane rubber adhesive, a styrene-butadiene-styrene (SBS) adhesive, a styrene-ethylene/butylene-styrene (SEBS) adhesive, a styrene-ethylene/propylene (SEP) adhesive, a styrene-isoprene-styrene (SIS) adhesive, and a carboxylated styrene-butadiene rubber adhesive; and
a tackifier, the tackifier comprising one or more of: a terpene, an aromatic resin, a hydrogenated hydrocarbon resin, a terpene-phenol resin, and a silicone tackifier.

6. The method of claim 1, providing the recycled portion of the pressure-sensitive adhesive laminate comprising one or more of:
suspending and dissolving the recycled portion in the process mixture;
at least partly uncoupling the recycled portion of the pressure-sensitive adhesive laminate from the pressure-sensitive adhesive laminate; and
one or more of:
the recycled portion of the pressure-sensitive adhesive laminate comprises portions of the facestock and the release liner delaminated from the pressure-sensitive adhesive laminate;
the recycled portion of the pressure-sensitive adhesive laminate comprises the pressure-sensitive adhesive at least partly dissolved in the process mixture; and
the recycled portion of the pressure-sensitive adhesive laminate comprises one or more of: the facestock, the release liner, the pressure-sensitive adhesive, a tackifier, a release agent, an abrasion coating, a textured coating, an ultraviolet-resistant coating, a clear coating, an ink, a dye, a paint, a pigment, a scented coating, and a decomposition product thereof.

7. The method of claim 1, further comprising recovering at least a portion of the single-phase aqueous solution after providing the recycled portion of the pressure-sensitive adhesive laminate.

8. The method of claim 1, further comprising:
heating and agitating the process mixture in a first step effective for:
delaminating at least the portion of the pressure-sensitive adhesive laminate, and
removing at least a first portion of the pressure-sensitive adhesive from the pressure-sensitive adhesive laminate;
replacing at least a portion of the single-phase aqueous solution from the process mixture with a fresh portion of the single-phase aqueous solution; and
heating and agitating the process mixture comprising the fresh portion of the single-phase aqueous solution in a second step effective for one or more of:
delaminating a further portion of the pressure-sensitive adhesive laminate, and
removing at least a second portion of the pressure-sensitive adhesive from the pressure-sensitive adhesive laminate.

9. The method of claim 1, comprising one or more of:
providing the water in a weight ratio to the pressure-sensitive adhesive laminate of one or more of about: 4:1 to 40:1; 6:1 to 35:1; 8:1 to 30:1; 10:1 to 25:1; 12.5:1 to 25:1; 12.5:1 to 20:1; and 13:1;
providing the surfactant composition in a weight percentage (w/w) with respect to the water of one or more of about: 0.025% to 1%; 0.05% to about 0.75%; 0.05% to 0.5%; 0.1% to 0.25%; 0.1% to about 0.2%; and 0.15%;
the surfactant composition comprising one or more of: an alkyl polyglycoside and an alkoxylated alcohol; and
the single-phase aqueous solution further comprising:
an inorganic base composition, the inorganic base composition comprising one or more of: an alkali metal hydroxide, an alkaline earth metal oxide, or an alkaline earth metal hydroxide; the inorganic base composition being present in a weight percent concentration (w/w) with respect to the water in a range of about one or more of: 0.1% to 5%, 0.1% to 4%, 0.1% to 3%, 0.1% to 2.5%, 0.2% to 2%, 0.5% to 1.6%, 0.5% to 1.2%, 0.6% to 1%, and 0.75%; and
a stable peroxygen composition, the stable peroxygen composition comprising an alkali metal salt of one or more of: peroxide, percarbonate, persulfate, and perborate; the stable peroxygen composition being present in a weight percentage (w/w) with respect to the water of one or more of about: 0.01% to 3%, 0.01% to 2.5%, 0.01% to 2%, 0.01% to 2%, 0.01% to 1.5%, 0.05% to 1.5%, 0.25% to 1.5%, 0.25% to 1.25%, 0.5% to 1.25%, 0.75% to 1.25%, and 0.75%.

10. A recycled portion of a pressure-sensitive adhesive laminate produced by the method of claim 1, comprising one or more of: a facestock, a release liner, a pressure-sensitive adhesive, a tackifier, a release agent, an abrasion coating, a textured coating, an ultraviolet-resistant coating, a clear coating, an ink, a dye, a paint, a pigment, a scented coating, and a decomposition product thereof.

11. A process mixture, comprising:
a pressure-sensitive adhesive laminate in contact with a single-phase aqueous solution;
the single-phase aqueous solution comprising: water and a surfactant composition; and
the pressure-sensitive adhesive laminate comprising:
a facestock, the facestock comprising a label surface and an adhesion surface;
a release liner, the release liner comprising a release surface; and
a pressure-sensitive adhesive coated on the adhesion surface of the facestock, the release surface of the release liner being laminated to the adhesion surface of the facestock through the pressure-sensitive adhesive to form the pressure-sensitive adhesive laminate.

12. The process mixture of claim 11, one or more of:
the facestock and release liner independently comprises a polymer film of one or more of: a polyester, a polyolefin, a cellulose derivative, a polystyrene, a polyvinyl, and a polyamide;
the facestock comprises a primer coating on the adhesion surface, the primer coating being configured to facilitate adhesion of the pressure-sensitive adhesive to the adhesion surface of the facestock;
the label surface of the facestock comprises or is in contact with one or more of: an abrasion coating, a textured coating, an ultraviolet-resistant coating, a clear coating, an ink, a dye, a paint, a pigment, and a scented coating; and
the release liner comprises a release agent coated on the release surface, the release agent comprising one or more of: a wax, a polyolefin, a silicone, an organofluorine compound, and a fluoropolymer.

13. The process mixture of claim 11, the pressure-sensitive adhesive comprising one or more of: a solvent-based acrylic adhesive, a water-based acrylic adhesive, a bio-based acrylic adhesive, a butyl rubber adhesive, a natural rubber adhesive, a nitrile rubber adhesive, a polyvinyl acetate adhesive, an ethylene-vinyl acetate (EVA) adhesive, a vinyl ether adhesive, a polydimethyl siloxane rubber adhesive, a styrene-butadiene-styrene (SBS) adhesive, a styrene-ethylene/butylene-styrene (SEBS) adhesive, a styrene-ethylene/propylene (SEP) adhesive, a styrene-isoprene-styrene (SIS) adhesive, and a carboxylated styrene-butadiene rubber adhesive.

14. The process mixture of claim 11, the pressure-sensitive adhesive comprising a tackifier, the tackifier comprising one or more of: a terpene, an aromatic resin, a hydrogenated hydrocarbon resin, a terpene-phenol resin, and a silicone tackifier.

15. The process mixture of claim 11, comprising a recycled portion of the pressure-sensitive adhesive laminate, the recycled portion of the pressure-sensitive adhesive laminate comprising one or more of: the facestock, the release liner, the pressure-sensitive adhesive, a tackifier, a release agent, an abrasion coating, a textured coating, an ultraviolet-resistant coating, a clear coating, an ink, a dye, a paint, a pigment, a scented coating, and a decomposition product thereof.

16. The process mixture of claim 11, comprising:
the water in a weight ratio with respect to the pressure-sensitive adhesive laminate of one or more of about: 4:1 to 40:1; 6:1 to 35:1; 8:1 to 30:1; 10:1 to 25:1; 12.5:1 to 25:1; 12.5:1 to 20:1; and 13:1; and
the water in a weight percent concentration (w/w) of the single-phase aqueous solution of at least about one or more of: 92%, 93%, 94%, 95%, 96%, 97%, 98%, 98.1%, 98.25%, 98.5%, 98.75%, and 99%.

17. The process mixture of claim 11:
the surfactant composition comprising one or more of: an alkyl polyglycoside and an alkoxylated alcohol; and
the surfactant composition being present in a weight percentage (w/w) with respect to the water of one or more of about: 0.025% to 1%; 0.05% to about 0.75%; 0.05% to 0.5%; 0.1% to 0.25%; 0.1% to about 0.2%; and 0.15%.

18. The process mixture of claim 11, one or more of:
the single-phase aqueous solution further comprising an inorganic base composition, the inorganic base composition comprising one or more of: an alkali metal hydroxide, an alkaline earth metal oxide, or an alkaline earth metal hydroxide;
the inorganic base composition being present in a weight percent concentration (w/w) with respect to the water in a range of about one or more of: 0.1% to 5%, 0.1% to 4%, 0.1% to 3%, 0.1% to 2.5%, 0.2% to 2%, 0.5% to 1.6%, 0.5% to 1.2%, 0.6% to 1%, and 0.75%; and
the process mixture being characterized by a pH value of about one or more of: 10 to 14; 10.5 to 14; 11 to 14; 11.5 to 14; 12 to 14; and 12.5 to 13.5.

19. The process mixture of claim 11, the single-phase aqueous solution further comprising a stable peroxygen composition, the stable peroxygen composition comprising an alkali metal salt of one or more of: peroxide, percarbonate, persulfate, and perborate;
the stable peroxygen composition being present in a weight percentage (w/w) with respect to the water of one or more of about: 0.01% to 3%, 0.01% to 2.5%, 0.01% to 2%, 0.01% to 2%, 0.01% to 1.5%, 0.05% to 1.5%, 0.25% to 1.5%, 0.25% to 1.25%, 0.5% to 1.25%, 0.75% to 1.25%, and 0.75%.

20. A recycled portion of a pressure-sensitive adhesive laminate derived from the process mixture of claim 11, comprising one or more of: a facestock, a release liner, a pressure-sensitive adhesive, a tackifier, a release agent, an abrasion coating, a textured coating, an ultraviolet-resistant coating, a clear coating, an ink, a dye, a paint, a pigment, a scented coating, and a decomposition product thereof.
